(19) United States
(12) Patent Application Publication
(10) Pub. No.: US 2009/0317213 A1
(43) Pub. Date: Dec. 24, 2009

(54) Buffer crane for facilitating simultaneous multiple cargo container handling

(75) Inventor: Kinya Ichimura, Foster City, CA (US)

Correspondence Address: BRUCE & MCCOY, ONE KAISER PLAZA, STE. 750, OAKLAND, CA, 94612, US

(73) Assignee: PACECO CORP.

(21) Appl. No.: 12/214,579

(22) Filed: Jun. 21, 2008

(51) Int. Cl. B65G 67/60

(52) U.S. Cl. 414/140.3

(57) ABSTRACT

A buffer crane for supplementing a quay crane operation and formed to operate thereunder with a landing deck for facilitating simultaneous multiple cargo container handling by the quay crane.

### BACKGROUND OF THE INVENTION

1. Field of the Invention

The present invention relates to a specialized buffer crane for assisting cargo container handling gantry cranes and, more particularly, it relates to a buffer crane for effecting the handling of multiple containers simultaneously. Specifically, it relates to a buffer crane which permits effecting reorientation of multiple containers for simultaneous handling in either a line of four, two different flats of four, or a block of four.

2. Description of the Prior Art

Shipping companies wish to reduce the time a ship spends in port involved in berthing operations in order to increase the efficiency of each vessel. Increasing the productivity of berthing operations allows ships to be loaded and unloaded faster, thereby effectively reducing the ship's down time. Efforts are continuously being made to further this objective. The present invention is yet another significant contribution to advancement in these efforts.

The utilization of various types of supplemental apparatus and methods for the purpose of increasing the speed of loading and unloading of cargo container transport ships by cargo container handling gantry cranes or quay cranes is well represented in the prior art. However, despite the numerous designs, structures, and forms of supplemental apparatus and methods disclosed by the prior art, which have been developed for the accomplishment of the specific objectives, purposes, and requirements for improving the efficiency of cargo container handling, the devices and apparatus which have heretofore been devised and utilized consist basically of familiar, expected, and obvious configurations, combinations, and arrangements of well-known machinery. This will become apparent from the following consideration of the closest known and relevant prior art.

Reference is made to FIGS. 1 and 2 of the drawings which show a typical dockside berthing operation for a ship. The primary container handling equipment is comprised of one or more quay cranes 11 which extend outboard from the dock's edge 13 across the beam of a ship 15. Cargo containers 17 which have been unloaded or are to be loaded are temporarily stored in a stacking yard 19 proximate to the ship's loading berths. The berthing operations under specific consideration involve the transport of containers between a container ship and the stacking yard.

In ship unloading operations, quay cranes 11 access the shipboard cargo containers from above the ship and move them to the ground level or onto dockside cargo container transporters 21 such as chassis trucks, trailer trucks, or automatically guided vehicles (AGVs). The transporters deliver the containers to the stacking yard 19 where other vehicles or cranes 23 transfer the containers to stacks. In early loading operations, quay cranes lifted the cargo containers from the dockside container transporters and moved them to the ship where they are lowered into shipboard cells and the reverse.

Quay cranes in the form of cargo container handling gantry cranes are arranged to extend over a longitudinal expanse and transfer cargo containers horizontally from one deposition area to another. The largest of such gantry cranes are primarily located dockside in shipping ports around the world as well as in railroad yards. Quay cranes generally have either a horizontal sliding boom or a cantilever boom, the latter of which can usually be raised by rotating it around its inboard end. Long span yard and quay cranes are typically supported by vertical structures located inboard from the ends of the crane gantry on rail mounted wheels. The present invention is a supplemental (crane) which can be utilized with any of these basic types of quay crane designs and operations.

Reference is made to FIG. 2 of the drawings which illustrates a typical cantilever boom type quay crane 11 having a buffer crane 25 of the present invention positioned there under. The quay crane cantilevered rotatable boom 27 is supported by the crane superstructure 29 mounted on crane truck wheels 31 which run on dock rails which are disposed parallel to the edge 13 of the harbor dock. The crane superstructure supports a horizontal gantry 33 disposed generally mid-height thereon at an elevated location above the cargo container pickup and deposition areas 35. The gantry has a backreach for permitting the crane to pick up and deposit containers from and onto container transporters 21 located under the backreach. The gantry is supported from below by the main legs of the superstructure.

In the cantilevered rotatable boom design for quay cranes, sheaves are disposed at the pinnacle 37 of the superstructure of the crane to guide wire rope reeving 39 which is used to lift the outboard or cantilevered end of the boom to the upright raised stowed position. The wire rope reeving raises the cantilevered boom by rotating it about its hinge point 43 at its inboard end proximate to the superstructure so that the gantry clears a ship superstructure when it maneuvers along the dock.

While, in most typical dockside applications, the gantry 33 of a cargo container handling quay crane is a slidable or a raisable cantilevered boom 27 extending from a crane superstructure 29 to project over a ship 15, other types of large gantry yard cranes supported at both ends are located in large cargo container storage or transfer areas. All of these cranes are similar to the gantry type crane of FIG. 2 in that they employ at least one movable trolley 45, usually with a suspended operator's cab 47, which shuttles along the gantry 33 and boom 27 suspending a cargo container lifting spreader 49. The spreader can be raised or lowered from the crane gantry by the operator and engages cargo containers from above the tops thereof.

The containers 17 are carried by a transporter 21 or are stacked on the dock or shipboard to permit them to be lifted by the trolley 45 for horizontal transport. During ship loading or unloading, the containers are shuttled between the dockside transporters and outboard along the gantry to where they are lowered into or extracted from the cells 51 of a cargo container transport ship.

The cargo container lift trolley 45, mounted on rails on the crane gantry sections 27, 33, can traverse from one end of the gantry to the other with a suspended container. A cargo container lifting spreader 49 is suspended from the trolley by means of a detachable headblock 41 which carries the fleet through suspension sheaves for the wire rope reeving. Different or variable length spreaders can be secured to the headblock to accommodate correspondingly different size containers.

Quay crane container handling speeds are measured in cycle rates. Unsteady quay crane operations result because the cranes move containers different distances depending upon the location of the container on a ship varying the cycle rate. For example, as a quay crane loads or unloads each column of containers spaced across the beam of the ship, the hoist travels a longer distance outboard for each successive column of containers and lowers and hoists longer for each container located deeper in the stack. The increased traveling distance and stationary time for the hoist, for each successive container, adds to the container handling time and the resulting cycle rate.

There are two highly interdependent berthing sub-operations: (1) quay crane handling; and (2) transport vehicle movements between the crane and the stacking yard. A delay in one of those sub-operations causes the other to pause and idle which reduces the overall productivity of the entire system. Several factors can cause delays in the two berthing sub-operations including: (1) unsteady or irregular quay crane operations; (2) the time required for effecting interbox connector (IBC) installation and removal processes; (3) delays in stacking yard operations that delay throughput of transport vehicles; (4) the time required for quay cranes performing alignment of containers with transport chassis; (5) congestion of transport vehicles under quay cranes; and (6) various other factors such as machinery operator mistakes or inexperience.

Unsteady quay crane operation, coupled with a constant number of transport vehicles allotted per crane, creates inefficiencies in the overall operation. When quay crane handling rates or cycle time are slow, transport vehicles must wait. In those instances where the quay crane handles containers quickly and cycle time is short, and if the number of transport vehicles is insufficient for the cycle time, the quay crane must wait before offloading the container onto a transport vehicle.

The interbox connector (IBC) installation and removal processes cause both quay cranes and transport vehicles to idle. IBCs are cone-shaped devices that lock stacked containers together on the ship. When quay cranes lift containers from the ship, the IBCs are still attached to the bottom of the container. Usually, the quay cranes must lower the container until it is a few feet above the port terminal dock level where a worker crew can reach underneath and remove the IBCs. The installation processes are just the reverse. The IBC operations cause a significant amount of quay crane and transport vehicle idle time to be induced into the system cycle time as well as exposing the workers to the possibility of injury from a swaying or dropped container or any other hazards associated with proximity to a lifted load and to continuous transport vehicle operations.

Delays in stacking yard operations also cause delays in the throughput of container transport vehicles. The vehicles load or unload containers at the stacking yard before returning to the cranes. Disruptions in the flow of transport vehicles to and from the quay crane loading area are caused by numerous factors such as driver inexperience and lack of familiarity with the apparatus and layout of the yard, as well as yard worker inexperience, which cause the delays in the stacking yard operations. If the disruptions are sufficiently severe, then the quay cranes must wait in idle for a transport vehicle to arrive.

Another source of delay results when quay cranes expend time aligning a suspended container with a container transport chassis during the container positioning and deposition process. The transport vehicles do not park in precise locations under the quay cranes. As a result, each container placement is in a slightly different location. This process of container lifting spreader alignment with the transport vehicle causes time-consuming delay in the quay cranes operation.

Finally, congestion of transport vehicles under the quay crane slows the rate at which containers are moved to and from the container ship. A solution to these problems was effected by the addition of a new and novel apparatus on the quay for servicing the gantry cranes. It involved the use of a buffer crane which absorbs the delays inherent in container transfer operations. Such a buffer crane is described in U.S. Pat. No. 6,652,211 B2.

To increase still further the efficiency of berthing operations, cargo container handling apparatus was developed at first to transport two containers simultaneously between a ship and dockside. Initially twin lifting of two containers was accomplished by an extended lifting spreader which lifted them together in end to end or tandem orientation. Eventually, the tandem twin lift designs did not work in practice from an operational standpoint because of the increased and variable lengths of containers which came into use in the shipping industry.

When container lengths commonly reached 40 feet, two containers of that length could not be lifted by the extended spreaders then in use. The containers would extend more than 20 feet past the end of the lifting spreaders with only 20 feet of one end of each engaged by a spreader and the load was too great. Even lifting just one 20 foot container without another container engaged with the other end of the tandem spreader imposes a severe imbalance and large torque on the quay gantry which creates an unsafe condition. Thus, the great advantage of twin lifting of containers in tandem to halve the quay crane cycle times and double the lift rate of the quay cranes essentially became ineffective. The problem was essentially overcome by switching to twin lifting two containers side by side which solved the imbalance problems. Japanese patent S5 4-6267 discloses this arrangement (in 1979).

Eventually the art of cargo container handling has involved lifting four containers simultaneously but with various apparatus: either in two different flats of four containers or a block of four containers depending upon the lifting spreader utilized by the quay crane. The present invention facilitates the transformation of cargo container orientations into any one of the three different orientations by a single apparatus. The buffer crane, simultaneous multiple cargo container handling operations, contemplated according to the buffer crane of the present invention, departs substantially from the conventional concepts, designs, and modes of quay crane operation taught by the prior art. In doing so, the present invention provides an apparatus and new method of operation primarily developed for the purpose of improving the overall efficiency of berthing operations by permitting the re-orientation and transfer of multiple cargo containers simultaneously. It accomplishes the result in a different and improved manner and with an overall new method of operation for the dockside handling of cargo containers.

The buffer crane of the present invention functions mainly by establishing a temporary storage or holding operation between the quay cranes and the transport vehicles which permits the re-orientation of the containers into a predetermined orientation so that four containers can be picked up and transported simultaneously by a quay crane or deposited by a quay crane for re-orientation for transport by individual dockside transporters. The buffer operation in effect constitutes a container reservoir between two of the three berthing sub-operations: quay crane handling and transport between the crane and the stacking yards. The temporary container storage reservoir crane permits the quay crane to reorient container alignments for simultaneous multiple container pickup or breakdown into smaller units.

### SUMMARY OF THE INVENTION

In view of the foregoing known and obvious disadvantages inherent in the prior art types of quay cranes and berthing operations presently existing and utilized in seaports, the present invention provides a new crane construction and method of quay crane operation wherein the same can be utilized to improve the efficiency of cargo container ship berthing operations.

The general purpose of the present invention, which will be described hereafter in greater detail, is to provide a new crane apparatus and function which has all of the advantages of the prior art mentioned above, as well as many novel features that result in new methods of berthing operations, which are not anticipated, rendered obvious, suggested, or even implied by any of the prior art of quay cranes and port berthing operations either alone or in any combination thereof.

The present invention is a buffer crane for facilitating simultaneous multiple cargo container handling. It is comprised of an elevated platform forming a landing deck where containers can be landed and temporarily stored by a quay crane when they are removed from shipboard or where containers picked off ground level transporters can be landed until they are picked up by the quay crane for transport to a ship. The platform is supported by motorized transport wheels for independent all-direction movement.

The buffer crane has a low profile whereby it can be positioned underneath the quay crane to receive cargo containers delivered therefrom during ship unloading as well as from container transporters during ship loading. The landing deck is arranged to permit at least four containers to be deposited alternatively thereon in either parallel alignment on predetermined container deposition positions located on the landing deck, or thereon in two pairs of parallel tandem alignment, or thereon in two pair of two stacked container deposition positions located on the landing deck. The platform supports a cargo container handling straddle crane mounted on rails disposed on the fore and aft edges of the platform and has cargo container lifting apparatus arranged to transfer containers between the predetermined deposition positions on the landing deck and cargo container transporters positioned below the platform.

These more important features of the invention have been broadly outlined in order that the detailed description thereof which follows may be better understood and in order that the present contribution to an improvement in the art may be better appreciated. There are additional features of the invention that will be described hereinafter and which will form supplemental subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the drawings. The invention is capable of being created in other embodiments and of being practiced and carried out in various ways. Also, it is to be understood that the phraseology and terminology employed here are for the purpose of description and should not be regarded as limiting.

As such, those skilled in the art will appreciate that the conception upon which this disclosure is based may readily be utilized as a basis for the designing of other forms, structures, methods, and systems for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a new sub-operation for shipping port berthing operations which provides a buffer between quay crane operations and the container transport vehicles which service a stacking yard.

It is another object of the present invention to provide a buffer operation for quay crane berthing operations which provides an intermediary landing deck for facilitating simultaneous multiple cargo container handling by a quay crane.

It is a further object of the present invention to provide a buffer crane to permit the transformation of multiple cargo container orientations delivered by a quay crane into several cargo container handling orientations for individual or multiple unit transport.

It is still another object of the present invention to provide a buffer crane for permitting the assembly of three different four container packet configurations for simultaneous four container handling orientations by a quay crane

And it is yet a further object of the present invention to provide a supplemental independently movable gantry crane which can be supplied to presently existing quay cranes without additional tracks on the dockside and which provides a landing deck for containers and performs a supplemental buffer sub-operation to quay crane operations and permits either the assembly of two or four cargo container packets for simultaneous quay crane handling or the disassembly of two or four cargo container packets for individual transport by dockside container transport vehicles.

Other objects and advantages of the present invention will become apparent when the method and apparatus of the present invention are considered in conjunction with the accompanying drawings.

### DESCRIPTION OF THE DRAWINGS

FIG. 1 is a schematic diagram in plan view of a ship berthing operation and a cargo container stacking yard;

FIG. 2 is a side elevation of a typical quay crane with a buffer straddle crane of the present invention located thereunder;

FIG. 3 is a perspective view of a buffer straddle crane of the present invention shown in operation;

FIG. 4 is a front elevation view of FIG. 3;

FIG. 5 is an operations diagram; and

FIG. 6 is a container predetermined deposition positions diagram for the buffer crane of the present invention.

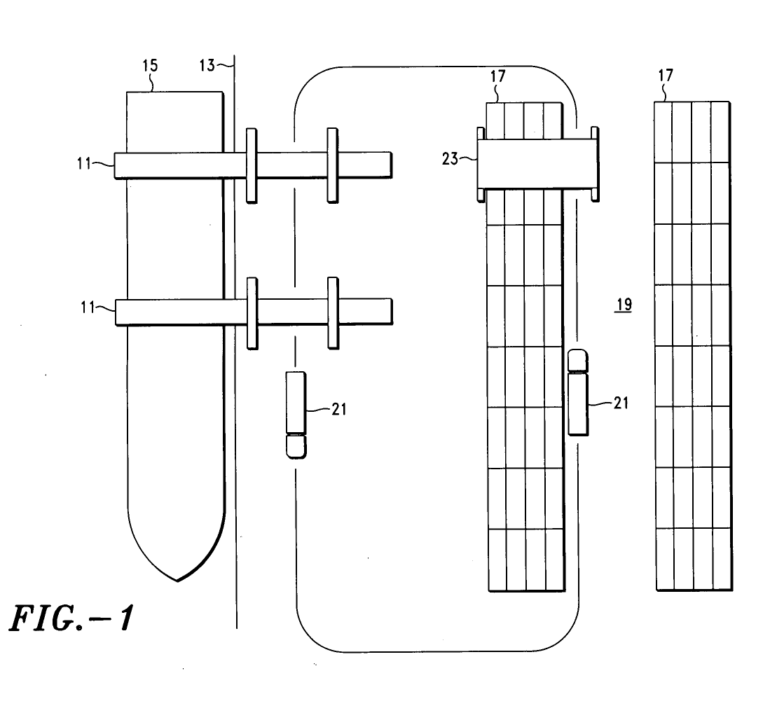

### DESCRIPTION OF THE PREFERRED EMBODIMENT

Reference is made to the drawings for a description of the preferred embodiment of the present invention wherein like reference numbers represent like elements on corresponding views.

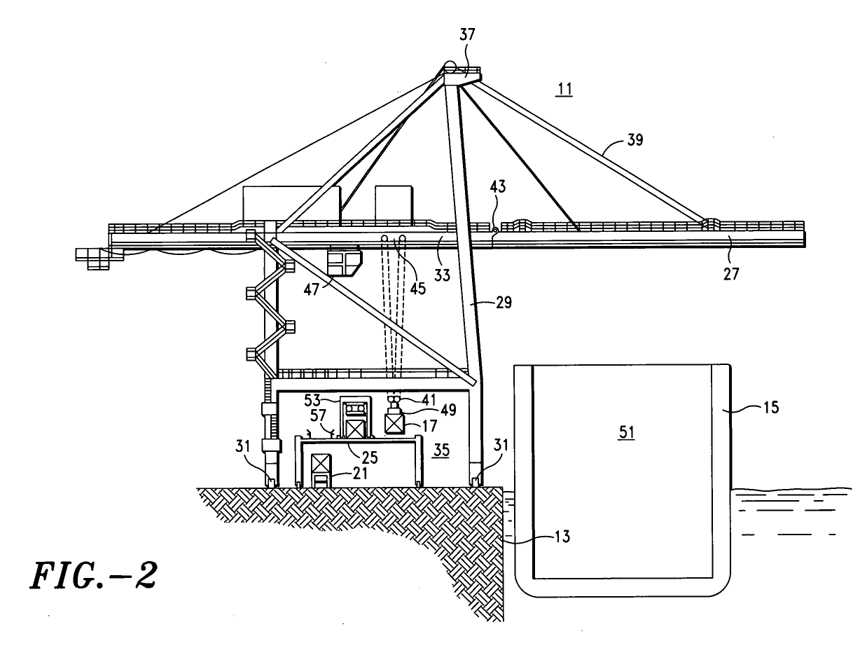

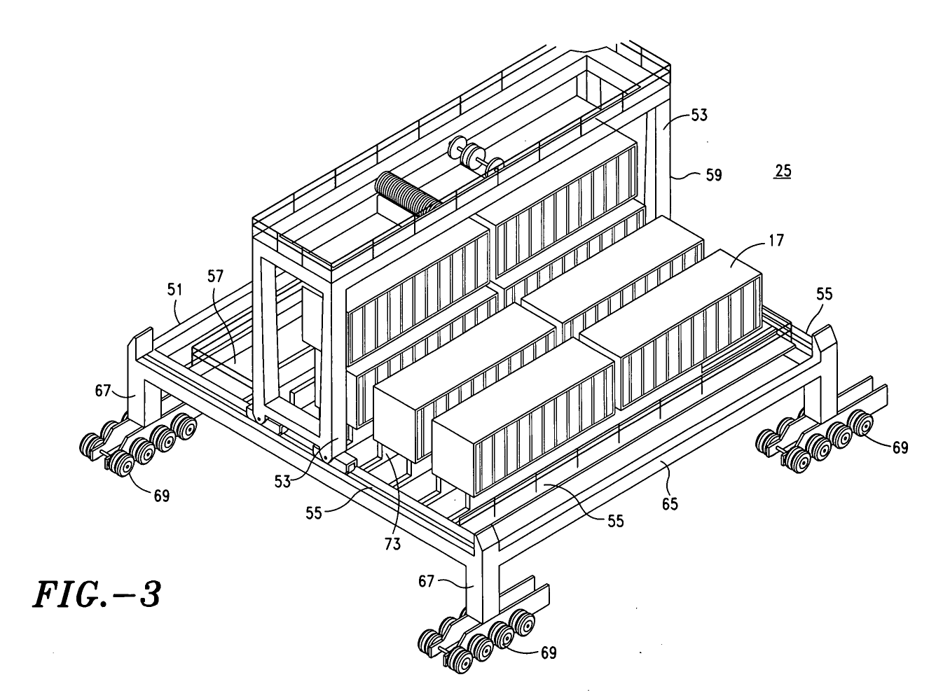

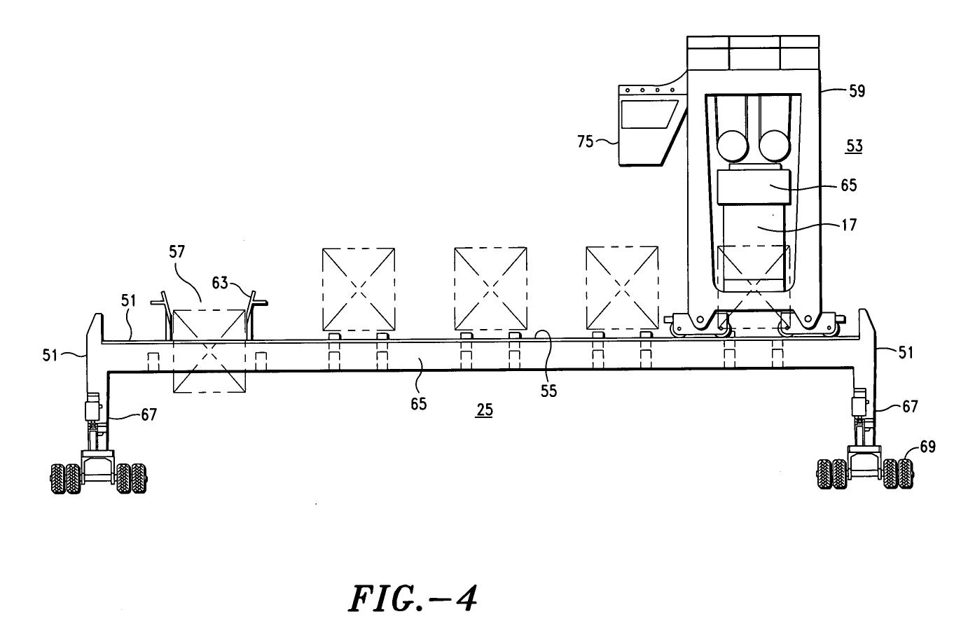

Reference is made to FIGS. 2 and 3 of the drawings which show the quay crane 11 and a buffer straddle crane 25 which are located dockside in a shipping port. The buffer crane is low profile so that it can be positioned underneath a quay crane during container handling operations.

FIG. 3 shows the buffer straddle crane 25 in operation. It is essentially an elevated wheeled landing platform or deck 51 where containers 17 can be landed by a quay crane 11, when they are removed from shipboard and temporarily stored, or where containers which have been picked off ground level transporters 21 can be landed until they are picked up by the quay crane for transport to a ship 15. The landing deck is provided with predetermined container landing positions to permit groupings of four cargo containers to be assembled for simultaneous pickup by the quay crane for ship loading or broken apart during ship offloading for distribution to individual container transporters.

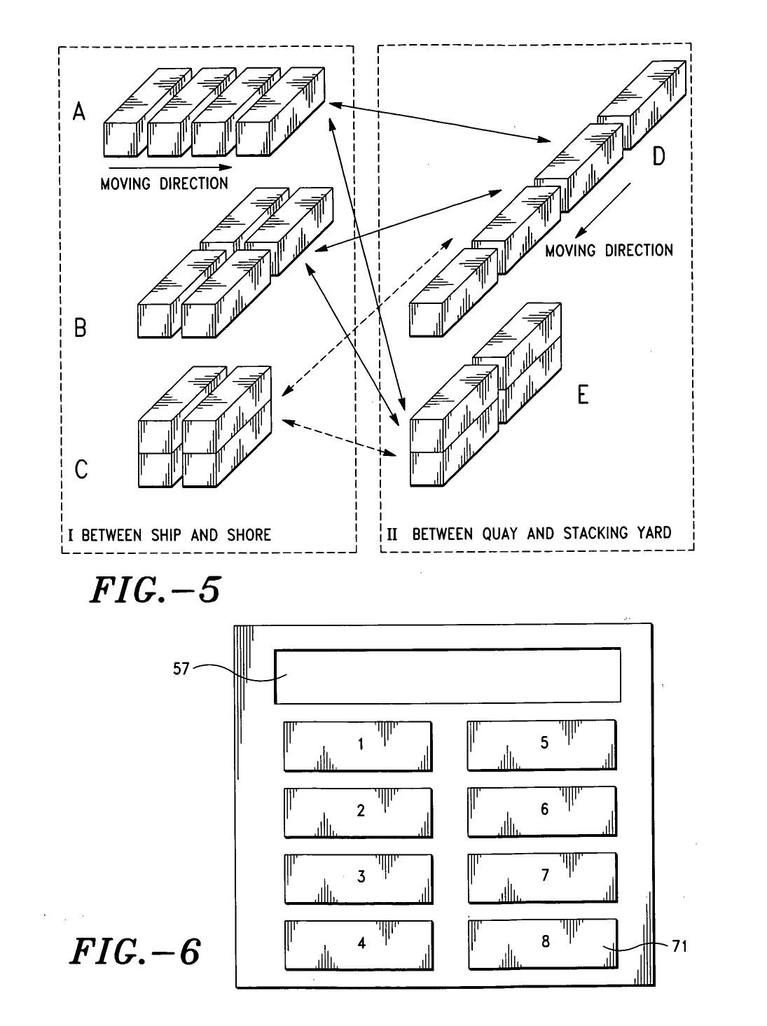

Reference is made to FIG. 5, section I. The container predetermined landing position groupings include three footprints: four parallel container alignments A; a pair of parallel tandem container alignments B; and a side-by-side alignment for a pair of single containers onto which a pair of containers can be stacked for a block of four C. The groupings between the ship and shore, section I, are configurations of groups of four containers which can be picked up and transported concurrently by a quay crane.

Reference is made to FIG. 5, section II. The groupings of containers are the largest size configurations which can be transported by ground level transporters concurrently: a string of four trailers D; or a pair of trailers stacked double high E. the present invention is formed to effect rapid transition of container groupings between the two operations: ship and shore transitions I; or quay and stacking yard transitions II.

Reference is made to FIGS. 3 & 4. The buffer straddle crane 25 is a gantry frame forming a raised or elevated landing platform or deck 51 which in turn supports a translatable bridge crane 53 mounted on rails 55 disposed at the edges of the landing platform and which can lift and lower containers through an opening 57 at the edge of the platform. The quay crane 11 deposits or picks up containers 17 onto or from the landing platform of the buffer crane while the bridge crane shuttles containers between the pre-determined landing positions 71 on the deck and container transporters 21 located below the landing platform.

The buffer crane 25 is repeatedly repositioned under a quay crane 11 as it moves along the dock 13 and interposes a container buffer reservoir between the quay crane and the container transport vehicles 21. The quay crane can take or extract containers 17 therefrom usually in blocks of two or four while the buffer crane can deliver single containers or two containers in tandem therefrom to the transporters. It creates a new and additional sub-operation in ship berthing operations which permits the assembly and disassembly of blocks of cargo containers for multiple container handling by a quay crane which reduces its cycle time in ship berthing operations.

The landing deck 51 can support multiple containers 17 in variable arrangements to function as the facilitator for assembling the multiple cargo container orientations for simultaneous container handling as well as functioning as the container reservoir or pool in the buffer operation. Container transport vehicles 21, such as chassis trucks, trailer trucks, or AGVs, are driven underneath the raised platform to either deliver or receive containers, singly or in tandem pairs, to and from the buffer crane landing deck.

The bridge crane 53 disposed above the landing deck 51 is a dedicated cargo container handling crane which moves the containers 17 between the transport vehicles 21, through at least one opening 57 in the landing deck. The opening is long enough to permit a tandem container lift to be effected simultaneously or for single containers to be transferred individually through the opening. Container guides 63 can be utilized to facilitate passing containers through the openings.

The bridge crane 53 supports cargo container handling apparatus in the form of lifting spreaders 65 above the landing deck 51 by legs 59 disposed at the fore and aft edges thereof. The bridge crane drops containers onto, and retrieves them from, dockside container transporters 21 located below the opening 57 in the landing deck. The bridge crane is tall enough to transition suspended containers over containers located at predetermined landing positions 71 and to stack containers two high on the landing deck. The bridge cane crane is also long enough to span two cargo containers aligned in tandem on the landing deck.

The cargo container lifting apparatus can be controlled by the crane operator vary the length of its engagement to a container to accommodate different size containers in the lengths of 20 feet, 40 feet, 45 feet, and two containers of 40 feet each, linked end-to-end. The cargo container lifting apparatus also has the ability to perform incremental adjustments of the container's position to facilitate alignment with the transport vehicles 21. The apparatus accomplishes this result by giving and taking varying amounts of slack in the suspension ropes. In this manner, the apparatus can skew, list, and trim the container, as well as move the container laterally and longitudinally. The lifting apparatus therefore can quickly position containers on transport vehicles thereby eliminating the time-consuming task from the quay crane's cycle time.

Port operators can perform certain tasks on the containers 17 from the safety of service decks disposed below the landing deck 51 while the containers rest thereon. The service decks can be provided with rigid shelters to protect service workers from descending containers and inclement weather. See U.S. Pat. No. 6,652,211 B2. The buffer crane system allows port operators to perform IBC installation and removal operations, and container interlock operations, while the containers rest in the buffer pool on the landing deck so that neither the quay crane nor the container transport systems need to idle during the IBC attachment or removal process. In addition, service personnel can verify container identification, re-mark a container, or perform minor container servicing while it resides on the landing deck.

The buffer crane landing deck 51 is supported at the corners thereof by four vertical support columns or legs 67. The legs are supported on pneumatic transport wheels 69 for independent self powered movement of the buffer crane 25 on the dock. The rigid structure provides structural support for the loads from the bridge crane 53, for the buffer containers 17 deposited on the landing deck 51, and for emergency impact situations and accidental occurrences. Shock absorbing mechanisms diminish the force of the continuous impacts which result from the container landing operations as well as impacts which occur in emergency situations. The inflated rubber tires augment the shock absorbing mechanisms.

The buffer crane 25 is mounted on tires 69 so that it can operate without tracks or rails and can turn. Since a quay crane moves along the dock as it unloads each successive row of container cells along the length of the ship, the buffer crane must likewise move along the dock to remain oriented under the quay crane. The buffer crane gantry drive is the arrangement of wheels, gear systems, drive motors, and brakes that allow the entire buffer crane system to move. By varying the speed of the tires, the crane can move in all directions and is omni-directional. A majority of the time, the wheels are aligned parallel to the edge of the dock which allows the gantry frame of the buffer crane to move in the same direction as the quay crane. In order to stay parallel with the quay crane, the buffer crane performs small turns by varying the wheel speeds on each side the crane.

Reference is made to FIG. 5. There shown are the transformations required to permit for concurrent container lifting in the various configurations which might be employed by different quay cranes. The first configuration A is for four containers in parallel alignment. The second configuration B is two pairs of tandem aligned containers in parallel alignment. The third configuration C is two pair of parallel aligned containers stacked two containers high. The eight predetermined container deposition positions 71 on the landing deck 51 required to permit creation of the three container grouping configurations A,B, & C, are shown in FIG. 6. This configuration also provides the buffer function by providing extra landing positions than those required for creating the three different four container grouping configurations required for four container concurrent handling by the quay crane.

The term “predetermined” means that the positions are specifically located for automatic computer control of the bridge crane 53 operation. Eight landing positions are provided for the intended purpose of effecting a container alignment transformation and buffer function apparatus, plus two phantom positions for transiting cargo containers 17 to and from the dock transporters 21.

The guides 73 for the opening 57 in the landing deck 51, through which containers can be lowered onto or raised from dockside transporters, form a container guide chute. They are positioned on the sides of the opening to stop the sway of a suspended container being lowered therethrough.

During lowering of the containers onto the landing deck, the bottom edges of the containers engage the guides which stop residual container sway of the suspended load and laterally displace the container into proper alignment onto the respective deposition position. The descending container slides downward along the guides in the vertical direction. Therefore, the computerized container landing process requires less precision than the methods utilized with container transport vehicles. This saves considerable time by reducing container positioning requirements.

Essentially, much less time is spent on the placement of a container because the quay cranes do not need to perform tedious positioning adjustments. The guides also place the containers in specific locations so that the straddle crane and the quay crane may accurately move to the predetermined deposition and pick-up positions above the landing deck by automated control. Similar guides can be positioned on the lower side of the landing deck for the related purpose: to stop the sway of a load being raised therethrough

Alternatively, each container landing position can be located over an opening through which containers may be raised or lowered by making the support members 73 retractable laterally when a container is raised therefrom to allow the container to be dropped or raised through the proximate opening in the landing deck. The guides 63 can be made retractable, to be moved into position concurrently or sequentially, to stop any sway in the suspended container prior to deposition onto a landing position.

Reference is made to FIG. 5. The three different four container grouping configurations of section I need to be realigned for single container handling for individual movement by a single transport vehicle or sequentially on a string of up to four trailers as shown in section II of FIG. 5. Alternatively, the dockside transport trailers can handle two containers stacked vertically on a trailer and two such trailers can be combined to move four containers at one time. The point is that handling four containers concurrently is the desired mode of operation whether servicing a ship or dockside.

The buffer crane 25 includes an automated control system for partial operation of the bridge crane 53 to position the cargo container lifting apparatus over the predetermined landing positions on the landing deck 51 and to move containers 17 with coordinated motion to reduce sway in the suspended load. The bridge crane moves automatically between the predetermined positions above the landing deck and the opening 57 or openings therein above the various transport vehicles 21 disposed there below.

The bridge crane operator only needs to select from the alternative predetermined container deposition positions 71 on the landing deck 51 to perform container engagement and pickup from a position and for container deposition at a selected position. Computer control performs precision alignment of the cargo containers 17 with respect to the landing deck positions and positioning of the bridge crane and 53 container lifting spreader 65 above the container transporters 21. The buffer crane operator controls the bridge crane for accurate alignment of the lifting spreader with the container transport vehicle for container pickup or deposition. Computer software also automatically controls the acceleration and movement of the bridge crane along the platform rails 55 to insure that the movement is smooth and linear during both operator and automatic control of the crane drive and lift mechanisms.

The bridge crane operator works in a cab 75 which contains all of the buffer and bridge crane 25,57 controls. Logistics are included to help the operator communicate with the quay crane operator and the service deck workers. Since the operator must communicate with so many individuals, it is essential that communication be clear and simplified to insure safety and productivity. Signal lights on the landing deck 51 automatically indicate to the quay crane driver which containers 17 are to be loaded onto the ship 15 or have already been unloaded. There are indicator lights controlled by the service workers which tell the buffer crane operator whether the IBCs have been removed or not so that the operator does not prematurely move the container. The operator cabin provides simplified controls for the crane driver by reason of the computer controlled positioning of the bridge crane at the predetermined deposition positions on the landing deck.

A diesel engine which is coupled to an alternator provides power to the buffer crane system, or it may be provided by electric cables. Weather protected steel enclosures protect the diesel engine and alternator couple from wear and possible damage.

During operation of the buffer crane 25, an electronic system automatically aligns the buffer crane with the quay crane along the cargo container transporter traffic lanes. The system can be comprised of optical, radio, or ultrasonic devices to measure the distance and relative position of the buffer crane to the quay crane. Information is linked to the quay drive system electronically which repositions the buffer crane until it is in the correct position directly below the quay crane trolley track and parallel to the quay crane quay wheels.

Another electronic system insures that there is no interference or collision between the quay crane 11 and bridge crane 25 lifting spreaders. With two devices accessing the landing deck, the quay crane and bridge crane, there is potential for interference and collision. The electronic systems will identify the position of the respective lifting spreaders to ensure that this does not occur.

The buffer crane system has features that improve productivity and safety of port operations. The buffer crane is a stand-alone machine. It can operate with any existing quay cranes. The quay cranes require only minimal modification to accommodate the electronic linking systems. There are no costs involved which would be due to required extensive crane modifications or crane downtime. Because the buffer crane 25 travels on rubber tires 69, the buffer operation does not require tracks, so there is no need to install additional rails on the port surface. The buffer crane has the advantage that is easy and inexpensive to install and can be applied to many cargo container handling ports in operation today.

The buffer crane 25 therefore resolves many of the delay issues described earlier. Even when one of the sub-operations of quay crane handling or container dockside transport is delayed, the other sub-operation may continue by accessing the containers on the buffer platform. The delayed sub operation can address the delay, and the companion crane continue its work. The complete elimination of IBC installation and removal operations from the quay crane cycle time provides a huge improvement in the efficiency of berthing operations.

In summary, the buffer crane system improves productivity and efficiency of port operations by providing a buffer operation between the quay cranes and transport vehicles sub-operations. This buffer crane intervention allows quay cranes and vehicles to operate independently so that delays in one sub operation do not slow the overall productivity. Additionally, the buffer system allows port operators to perform tasks on containers such as marking and inspection while they sit on the buffer platform rather than having the quay cranes and transport vehicles wait while those operations are performed.

Thus, it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. A buffer crane for facilitating simultaneous multiple cargo container handling comprising
an elevated platform forming a landing deck where containers can be landed and temporarily stored by a quay crane when they are removed from shipboard or where containers picked off ground level transporters can be landed until they are picked up by the quay crane for transport to a ship, said platform being supported by motorized transport wheels for independent all-direction movement, said buffer crane having a low profile whereby it can be positioned underneath said quay crane to receive cargo containers therefrom as well as from said container transporters and whereby said quay crane can extract containers therefrom and said buffer crane can deliver containers therefrom to said transporters, said landing deck arranged to permit at least four containers to be positioned thereon in parallel alignment on container deposition positions located on said landing deck or in two pairs of tandem alignment container deposition positions located on said landing deck, and
a cargo container handling straddle crane mounted on rails disposed on the fore and aft edges of said platform and having container lifting apparatus arranged to transfer containers between said landing deck and said transporters located alongside said platform, said straddle crane having a height sufficient to clear over at least two stacked containers on said landing deck and a length to clear over two tandem aligned containers deposited on said landing deck.

2. The buffer crane of claim 1 wherein said straddle crane has fore and aft legs supporting a bridge which suspends said container lifting apparatus above said landing deck, the lower ends of said legs being mounted on motor driven wheel carriages engaged with said platform rails for reciprocating lateral motion of said bridge over the width of said landing deck and said opening in said platform, said bridge spanning the length of said landing deck whereby containers can be moved laterally along said landing deck to and from said opening therein whereby containers can be transferred therethrough between container transporters parked underneath said buffer crane and said landing deck.

3. The buffer crane of claim 2 within said straddle crane and said cargo container lifting apparatus with a container suspended therefrom are arranged on said platform at a level to pass above cargo containers deposited on said landing deck and remain below the supporting structure of any cargo container quay crane said straddle crane is positioned under.

4. The buffer crane of claim 3 including at least one service platform disposed proximate to said landing deck to permit workers to install and remove interbox connectors from cargo containers deposited on said deposition positions located on said landing deck.

5. The buffer crane of claim 4 including service platforms disposed on both sides of each of said deposition positions located on said landing deck to permit service workers to install or remove interbox connectors secured to corners of cargo containers deposited on said landing positions from the sides thereof.

6. The buffer crane of claim 5 including an automated control system for partial operation of said straddle crane to position said cargo container lifting apparatus over predetermined deposition positions on said landing deck and to move containers with coordinated motion.

7. A buffer straddle crane for cargo container handling comprising
an elevated platform forming a landing deck where containers can be landed and temporarily stored by a quay crane when they are removed from shipboard or where containers picked off ground level transporters can be landed until they are picked up by the quay crane for transport to a ship, said platform having at least one opening in said landing deck where containers can be lowered and raised therethrough, said platform being supported by motorized transport wheels for independent all-direction movement, said buffer crane having a low profile whereby it can be positioned underneath said quay crane to receive cargo containers therefrom as well as from said container transporters and whereby said quay crane can extract containers therefrom and said buffer crane can deliver containers therefrom to said transporters, said landing deck arranged to permit at least four containers to be positioned thereon in parallel alignment on container deposition positions located on said landing deck or in two pairs of tandem alignment container deposition positions located on said landing deck,
a straddle crane having fore and aft legs supporting a bridge which suspends container lifting apparatus above said landing deck, the lower ends of said legs being mounted on motor driven wheel carriages engaged with said platform rails for reciprocating lateral motion of said bridge over the width of said landing deck and said opening in said platform, said bridge spanning the length of said landing deck whereby containers can be moved laterally along said landing deck to and from said opening therein whereby containers can be transferred therethrough between container transporters parked underneath said buffer crane and said landing deck, said straddle crane and said cargo container lifting apparatus with a container suspended therefrom being arranged on said platform at a level to pass above cargo containers deposited on said landing deck and remain below the supporting structure of any cargo container quay crane it is positioned under, said straddle crane having a height sufficient to clear over at least two stacked containers on said landing deck and a length to clear over two tandem aligned containers deposited on said landing deck,
a multiplicity of predetermined parallel container deposition positions located on said landing deck service platforms disposed on both sides of each of said deposition positions located on said landing deck to permit service workers to install or remove interbox connectors secured to corners of cargo containers deposited on said landing positions from the sides thereof, and
an automated control system for at least partial operation of said straddle crane to position said cargo container lifting apparatus over said predetermined deposition positions on said landing deck and to move containers with coordinated motion.
